(19) United States
(12) Patent Application Publication
(10) Pub. No.: US 2025/0236119 A1
(43) Pub. Date: Jul. 24, 2025

(54) LIQUID APPLICATION SYSTEM AND EXHAUST VOLUME CONTROL METHOD

(71) Applicants: Junichi Matsumoto, KANAGAWA (JP); Noriaki Fukube, KANAGAWA (JP); Naoto Suzuki, KANAGAWA (JP); Hirokazu Ikenoue, TOKYO (JP); Keisuke Yuasa, KANAGAWA (JP); Tetsuya Ohba, KANAGAWA (JP); Yoshiaki Hoshino, KANAGAWA (JP); Sho Sawahata, TOKYO (JP); Jun Matsushima, KANAGAWA (JP); Yuji Karikusa, KANAGAWA (JP)

(72) Inventors: Junichi Matsumoto, KANAGAWA (JP); Noriaki Fukube, KANAGAWA (JP); Naoto Suzuki, KANAGAWA (JP); Hirokazu Ikenoue, TOKYO (JP); Keisuke Yuasa, KANAGAWA (JP); Tetsuya Ohba, KANAGAWA (JP); Yoshiaki Hoshino, KANAGAWA (JP); Sho Sawahata, TOKYO (JP); Jun Matsushima, KANAGAWA (JP); Yuji Karikusa, KANAGAWA (JP)

(73) Assignee: Ricoh Company, Ltd., Tokyo (JP)

(21) Appl. No.: 19/001,962

(22) Filed: Dec. 26, 2024

(30) Foreign Application Priority Data
Jan. 18, 2024 (JP) 2024-006113

(51) Int. Cl. B41J 11/00

(52) U.S. Cl. CPC B41J 11/00224; B41J 11/00222

(57) ABSTRACT

A liquid application system includes a liquid discharger to apply a liquid to a sheet, a heater to heat the sheet to which the liquid is applied, an exhauster to exhaust air from the heater, and circuitry to control an exhaust volume by the exhauster based on an amount of vapor from the sheet in the heater.

### CROSS-REFERENCE TO RELATED APPLICATIONS

This patent application is based on and claims priority pursuant to 35 U.S.C. § 119(a) to Japanese Patent Application No. 2024-006113, filed on Jan. 18, 2024, in the Japan Patent Office, the entire disclosure of which is hereby incorporated by reference herein.

### BACKGROUND

### Technical Field

The present disclosure relates to a liquid application system and an exhaust volume control method.

### Related Art

One type of liquid application apparatus known in the art is an image forming apparatus that applies ink to a sheet to form an image on the sheet.

Some of such image forming apparatuses include a drying device to dry the sheet to which the ink is applied.

For example, the drying control system determines a target value of a drying condition according to the amount of ink applied to a sheet when drying the sheet to which ink is applied, and controls a drying unit based on the determined target value.

### SUMMARY

The present disclosure described herein provides a liquid application system that includes a liquid discharger to apply a liquid to a sheet, a heater to heat the sheet to which the liquid is applied, an exhauster to exhaust air from the heater, and circuitry to control an exhaust volume by the exhauster based on an amount of vapor from the sheet in the heater.

The present disclosure described herein provides a method for controlling an exhaust volume from a heater that heats a sheet. The method includes controlling the exhaust volume from the heater based on an amount of vapor from the sheet in the heater.

### BRIEF DESCRIPTION OF THE DRAWINGS

A more complete appreciation of embodiments of the present disclosure and many of the attendant advantages and features thereof can be readily obtained and understood from the following detailed description with reference to the accompanying drawings, wherein:

FIG. 1 is a schematic diagram illustrating a configuration of an image forming system according to a first embodiment of the present disclosure;

FIG. 2 is a schematic block diagram illustrating a hardware configuration of a controller, relating to image formation, according to the first embodiment;

FIG. 3 is a schematic diagram illustrating a configuration of a heater according to the first embodiment;

FIG. 4 is a perspective view of an air blowing device according to the first embodiment as viewed from the side facing a sheet;

FIG. 5 is a perspective view of the air blowing device illustrated in FIG. 4, cut in the longitudinal direction thereof;

FIG. 6 is a block diagram illustrating an overall configuration of the controller according to the first embodiment;

FIG. 7 is a diagram illustrating an exhaust volume setting table used for setting exhaust volume according to the first embodiment;

FIG. 8 is a flowchart of a process for controlling the exhaust volume using the exhaust volume setting table illustrated in FIG. 7;

FIG. 9 is a table of exhaust volume levels set based on total score of exhaust-volume setting items according to the first embodiment;

FIG. 10 is a schematic diagram illustrating a configuration of an image forming apparatus according to a second embodiment of the present disclosure;

FIG. 11 is a block diagram illustrating a configuration of a part of a controller according to the second embodiment;

FIG. 12 is a schematic diagram illustrating a configuration of an image forming apparatus according to a third embodiment of the present disclosure;

FIG. 13 is a block diagram illustrating a configuration of a part of a controller according to the third embodiment;

FIG. 14 is a schematic diagram illustrating a configuration of an image forming apparatus according to a fourth embodiment of the present disclosure; and

FIG. 15 is a block diagram illustrating a configuration of a part of a controller according to the fourth embodiment.

The accompanying drawings are intended to depict embodiments of the present disclosure and should not be interpreted to limit the scope thereof. The accompanying drawings are not to be considered as drawn to scale unless explicitly noted. Also, identical or similar reference numerals designate identical or similar components throughout the several views.

### DETAILED DESCRIPTION

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

Referring now to the drawings, embodiments of the present disclosure are described below. As used herein, the singular forms “a,” “an,” and “the” are intended to include the plural forms as well, unless the context clearly indicates otherwise. In the drawings, like reference signs are assigned to elements such as components and parts that have a like function or a like shape as far as distinguishable, and redundant descriptions of elements once described may be omitted.

Initially, a configuration of an image forming system which is an example of a liquid application system will be described.

### Configuration of Image Forming System

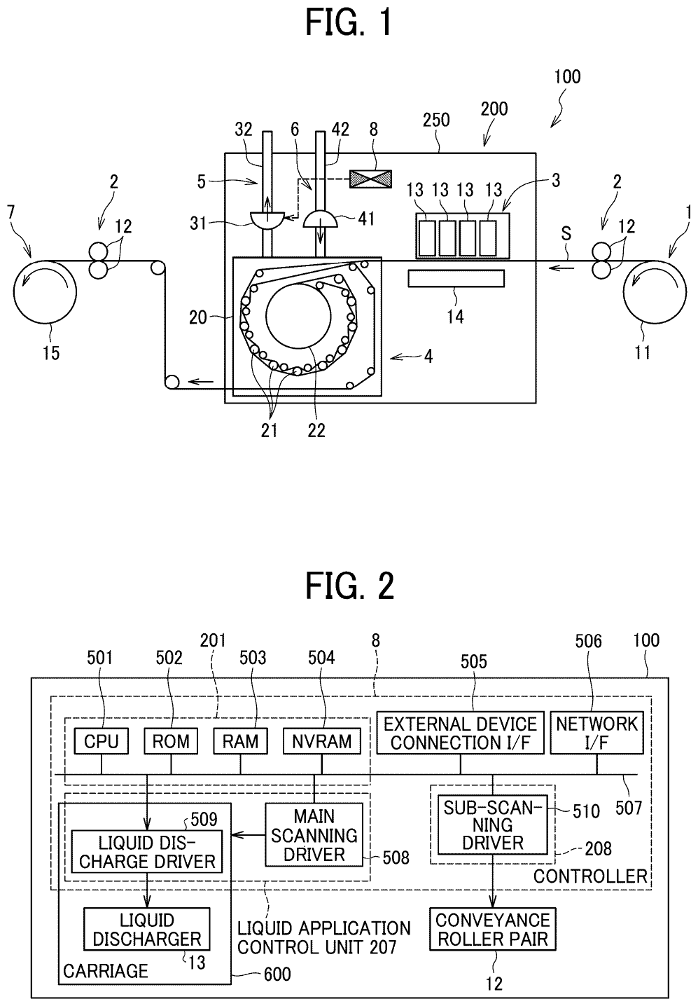

FIG. 1 is a schematic diagram illustrating a configuration of an image forming system 100 according to a first embodiment of the present disclosure.

As illustrated in FIG. 1, the image forming system 100 includes a sheet feeder 1, a conveyor 2, a liquid applying unit 3, a heater 4, an exhaust unit 5 (an exhauster), an air supply unit 6 (an air supplier), a sheet collecting unit 7, and a controller 8. The liquid applying unit 3, the heater 4, the exhaust unit 5, and the air supply unit 6 are accommodated in one housing 250 and together function as an image forming apparatus 200 in the first embodiment. The liquid applying unit 3, the heater 4, the exhaust unit 5, and the air supply unit 6 are not necessarily accommodated in the same housing 250 and may be accommodated in separate housings.

The sheet feeder 1 includes a feed roller 11 on which a long sheet S is wound in a roll shape. When the feed roller 11 rotates in the direction indicated by an arrow in FIG. 1, the sheet S is fed from the feed roller 11. The sheet S may be a pre-cut sheet of a predetermined size. In this case, for example, a feed roller to feed sheets of a predetermined size one by one is used in the sheet feeder 1.

The conveyor 2 includes conveyance roller pairs 12 that convey the sheet S while sandwiching the sheet S. The conveyor 2 may include a conveyor belt that conveys the sheet S while attracting the sheet S, not limited to the conveyance roller pair 12.

The liquid applying unit 3 includes multiple liquid dischargers 13 (image forming devices) that apply liquid onto the sheet S. The liquid dischargers 13 are liquid discharge heads that discharge liquid (ink) of different colors such as black, cyan, magenta, and yellow, respectively. The liquid applying unit 3 may include one liquid discharge head (an image forming device) that discharges liquids of different colors as the liquid discharger 13. The discharge method of the liquid discharger 13 is not limited, and examples thereof include an on-demand method of discharging fine liquid droplets and a continuous method of continuously discharging liquid. Examples of the on-demand method include a pressure application method in which a piezoelectric element is used as a driving source for discharging liquid, a thermal method in which liquid is discharged by pressure of bubbles arising from heating of liquid, and an electrostatic method in which electrostatic force is used. The colors of the liquid discharged from the liquid dischargers 13 are not limited to black, cyan, magenta, and yellow and can be freely selected. In FIG. 1, a conveyance guide 14 that supports the sheet S to be conveyed is disposed below the liquid dischargers 13.

The heater 4 functions as a drying device that dries the sheet S by heat. Specifically, in the first embodiment, the heater 4 includes heating means such as a heating roller 21 and a heating drum 22 to heat the sheet S. When the sheet S is fed into the heater 4, the sheet S contacts the heating roller 21 and the heating drum 22 and is dried by the heat thereof.

The heating means is not limited to a contact heating means such as the heating roller 21 and the heating drum 22, and may be a noncontact heating means such as a means that emits infrared rays or ultraviolet rays to heat the sheet S.

The exhaust unit 5 is a means for exhausting air from the heater 4. Specifically, the exhaust unit 5 includes an exhaust fan 31 as an air blowing means and an exhaust duct 32 as an exhaust passage.

The air blowing means is not limited to the exhaust fan 31 but may be, for example, a blower. The exhaust duct 32 extends from a housing (casing) 20 of the heater 4 to the outside of a housing (casing) 250 of the image forming apparatus 200. The exhaust fan 31 is coupled to the exhaust duct 32. The exhaust fan 31 is coupled to the exhaust duct 32 at a position outside the heater 4 (the housing 20) and inside the body (the housing 250) of the image forming apparatus 200. Alternatively, the exhaust fan 31 may be coupled to the exhaust duct 32 at a position outside the image forming apparatus 200 (the housing 250).

The air supply unit 6 is a means for supplying air into the heater 4. Specifically, the air supply unit 6 includes an air supply fan 41 as an air supplying means and an air supply duct 42 as an air supply passage.

Instead of the air supply fan 41, an air blowing means such as a blower may be used. The air supply duct 42 extends from the housing 20 of the heater 4 to the outside of the housing 250 of the image forming apparatus 200, like the exhaust duct 32. Further, the air supply fan 41 is coupled to the air supply duct 42 at a position outside the heater 4 (the housing 20) and inside the body (the housing 250) of the image forming apparatus 200. Alternatively, the air supply fan 41 may be coupled to the air supply duct 42 at a position outside the image forming apparatus 200 (the housing 250).

The sheet collecting unit 7 includes a collection roller 15 that winds and collects the sheet S. When the collection roller 15 is driven to rotate in the direction indicated by the arrow in FIG. 1, the sheet S is wound in a roll shape around the collection roller 15 and collected. When the sheet S is a pre-cut sheet of a predetermined size, the sheet collecting unit 7 includes an ejection tray on which ejected sheets are stacked.

The controller 8 is, for example, an information processing apparatus that controls the overall operation of the image forming system 100.

For example, the controller 8 controls the sheet conveying operation of the conveyor 2, the liquid applying operation of the liquid applying unit 3, the heating operation of the heater 4, and the exhaust operation of the exhaust unit 5.

### Image Forming Operation

With continued reference to FIG. 1, the image forming operation of the image forming system 100 is described below.

When the image forming operation is started, the feed roller 11 starts rotating, and the sheet S is fed from the feed roller 11.

The fed sheet S is conveyed below the liquid dischargers 13 by the conveyance roller pair 12, and the liquid dischargers 13 discharge the liquid (ink) onto the sheet S. Thus, an image is formed on the sheet S.

The sheet S is then conveyed to the heater 4. In the heater 4, the sheet S being conveyed contacts the heating roller 21 and the heating drum 22, and the sheet S is heated. Then, the liquid on the sheet S evaporates, and the drying of the ink on the sheet S is promoted.

The sheet S conveyed out of the heater 4 and is conveyed to the collection roller 15 by the conveyance roller pair 12. Then, the sheet S is wound and collected by the rotating collection roller 15. Thus, a series of image forming operations is completed.

### Configuration of Controller

FIG. 2 is a schematic block diagram illustrating a hardware configuration relating to image formation in the controller 8.

As illustrated in FIG. 2, the controller 8 includes a central processing unit (CPU) 501, a read-only memory (ROM) 502, a random-access memory (RAM) 503, a nonvolatile random-access memory (NVRAM) 504, an external device connection interface (I/F) 505, a network I/F 506, and a bus line 507.

The CPU 501 controls the overall operation of the image forming system 100. The ROM 502 stores programs such as an initial program loader (IPL) used for driving the CPU 501. The RAM 503 is used as a work area for the CPU 501. The NVRAM 504 stores various kinds of data such as a program and holds various kinds of data even when the power source for the image forming apparatus 200 is cut out.

The external device connection I/F 505 is connected to a personal computer (PC) via, for example, a universal serial bus (USB) cable and exchanges with the PC control signals and data of images to be printed. The network I/F 506 is an interface for data communication with an external device through a communication network such as the Internet. The bus line 507 is, for example, an address bus or a data bus and electrically connects the components such as the CPU 501.

The controller 8 includes a main scanning driver 508 and a liquid discharge driver 509. The main scanning driver 508 controls the movement of a carriage 600 on which the liquid dischargers 13 are mounted in the main scanning direction, i.e., the width direction of the sheet S. The liquid discharge driver 509 controls the driving of the liquid dischargers 13. When the carriage 600 moves in the main scanning direction (width direction of the sheet S), the liquid dischargers 13 mounted therein also move in the main scanning direction and discharge the liquids onto the sheet S that is intermittently conveyed. Thus, an image is formed on the sheet S.

The controller 8 includes a sub-scanning driver 510. The sub-scanning driver 510 controls the conveyance of the sheet S by the conveyance roller pairs 12.

The liquid discharger 13 may be a serial liquid discharge head that discharges liquid onto a sheet while moving in the width direction of the sheet or a line liquid discharge head that discharges liquid onto a sheet without moving. The liquid discharge driver 509 may be coupled to the bus line outside the carriage 600 not mounted on the carriage 600. The function of any one or more of the main scanning driver 508, the liquid discharge driver 509, and the sub-scanning driver 510 may be implemented by commands of the CPU 501 operating according to a program.

### Configuration of Heater

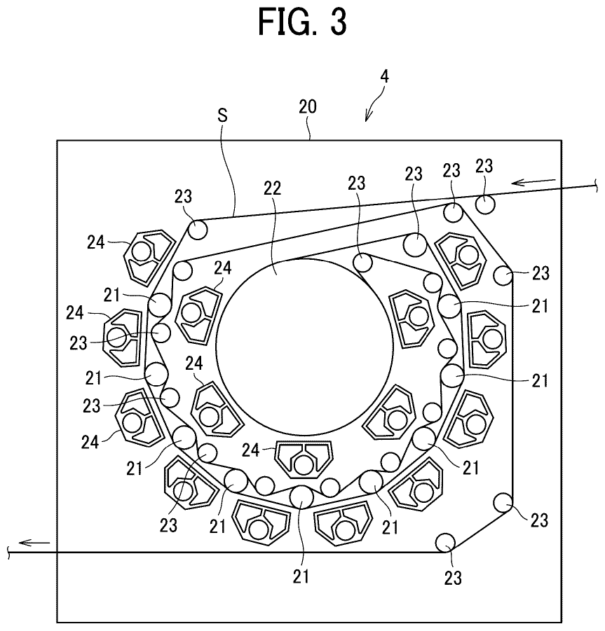

FIG. 3 is a schematic diagram illustrating a configuration of the heater 4.

As illustrated in FIG. 3, the heater 4 includes a guide roller 23 and an air blowing device 24 in addition to the heating roller 21 and the heating drum 22.

The heating roller 21 and the heating drum 22 are each a cylindrical heating rotator containing a heat source such as a halogen heater therein. In the first embodiment, one heating drum 22 larger in diameter than the heating roller 21 is disposed at the center of the heater 4, and multiple heating rollers 21 are disposed around the heating drum 22. However, the arrangement and the numbers of the heating roller 21 and the heating drum 22 are not limited to this and can be changed as appropriate.

The guide roller 23 is a cylindrical rotator containing no heat source therein and is a member that guides the sheet S. Multiple guide rollers 23 are disposed in the heater 4. As the sheet S is stretched over the guide roller 23, the heating roller 21, and the heating drum 22, a conveyance passage for conveying the sheet S is formed.

The air blowing device 24 blows air onto the sheet S to promote drying of the sheet S. Multiple air blowing devices 24 are arranged to face the sheet S.

When the sheet S is fed into the heater 4 having such a configuration, the sheet S is guided by the guide rollers 23 and is looped around the outer portions of the heating rollers 21. The term “outer portion” of the heating roller 21 means a portion of the outer circumferential surface of the heating roller 21 opposite to the portion facing the heating drum 22 and is farther from the heating drum 22 in the radial direction. As a result, the surface of the sheet S opposite to the image forming surface contacts the outer portions of the heating rollers 21, and the sheet S is heated. The sheet S is then looped around the heating drum 22. The sheet S is guided from the heating drum 22 again to the heating rollers 21 and is conveyed while being in contact with the inner portions (facing the heating drum 22) of the heating rollers 21.

In this way, after contacting the outer portions of the heating rollers 21, the sheet S is wound around the heating drum 22 and then is conveyed while contacting the inner portions of the heating rollers 21. Thus, the surface of the sheet S opposite to the image forming surface is effectively heated. Further, the drying of the sheet S is promoted by the air blown from the air blowing devices 24 to the image forming surface of the sheet S. Thus, the sheet S is dried and then is ejected from the heater 4 by the guide roller 23.

### Prevention of Dew Condensation

When the sheet S is heated by the heater 4, moisture or a solvent contained in the liquid applied to the sheet S is released as vapor. When the sheet S is heated, moisture contained in the sheet S itself is also released as vapor. Such vapor stays in a gaseous state for a while. When the vapor is cooled and condensed in the heater 4, water droplets adhere to the sheet S, which may cause an image defect.

In view of this, the air in the heater 4 is discharged by the exhaust unit 5 illustrated in FIG. 1. Since the vapor arising from the sheet S is exhausted to the outside of the image forming apparatus 200 together with the air from the heater 4, dew condensation in the heater 4 can be reduced. The vapor may be exhausted to the outside of the heater 4 but is preferably exhausted to the outside of the image forming apparatus 200 to prevent image defects. The destination of the vapor may be outdoors in consideration of the influence on the environment caused by the solvent vaporized from the liquid.

### Configuration of Air Blowing Device

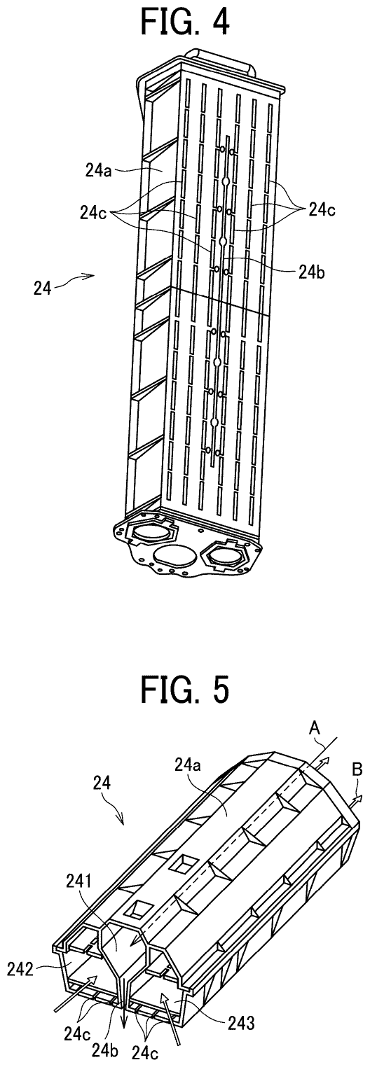

The air blowing device 24 will be described with reference to FIGS. 4 and 5.

FIG. 4 is a perspective view of the air blowing device 24 as viewed from the side facing the sheet. FIG. 5 is a perspective view of the air blowing device 24 cut in the longitudinal direction. Since the air blowing devices 24 have the same configuration, a configuration of one air blowing device 24 will be described with reference to FIGS. 4 and 5.

As illustrated in FIG. 4, the air blowing device 24 includes a housing 24a having an airflow path therein. The air blowing device 24 further includes an air outlet 24b and air intakes 24c on the sheet facing side of the housing 24a.

As illustrated in FIG. 5, the inside of the housing 24a of the air blowing device 24 is roughly divided into three airflow paths 241, 242, and 243. The airflow path 241 at the center of the three airflow paths 241, 242, and 243 is for air supply. The airflow paths 242 and 243 at both ends are for exhaust. The airflow path 241 for air supply communicates with the air outlet 24b. The airflow path 241 for air supply also communicates with the air supply duct 42 illustrated in FIG. 1. The airflow paths 242 and 243 for exhaust communicate with the air intakes 24c and the exhaust duct 32 illustrated in FIG. 1.

When the exhaust fan 31 and the air supply fan 41 illustrated in FIG. 1 are driven, airflow is generated in the exhaust duct 32 and the air supply duct 42, and air flows in the direction of arrow A and the direction of arrow B in FIG. 5 in the air blowing device 24. As a result, air is blown out from the air outlet 24b onto the sheet.

Further, air is sucked from the air intakes 24c into the airflow paths 242 and 243 for exhaust. The air flows through the airflow paths 242 and 243 and is exhausted outside the image forming apparatus 200 through the exhaust duct 32 illustrated in FIG. 1. Thus, the vapor released from the sheet heated in the heater 4 is exhausted outside the apparatus together with the air in the heater 4.

### About Exhaust

To effectively reduce the condensation inside the heater, the temperature inside the heater is preferably raised by, for example, supplying warm air into the heater. On the other hand, when vapor is exhausted from the heater to the outside of the apparatus, the air is also exhausted from the heater together with the vapor, resulting in a loss of thermal energy. In view of this, the exhaust volume is preferably kept minimum.

The exhaust volume is so far set according to the condition under which the amount of vapor arising is largest. Accordingly, when the amount of vapor is small, thermal energy is unnecessarily discharged, and energy for driving the exhaust unit is consumed more than necessary. Thus, there is unnecessary energy loss relating to exhaust.

In the following, controlling the exhaust volume based on the amount of vapor arising from sheets is proposed to reduce the energy loss relating to exhaust.

### Configuration for Exhaust Control

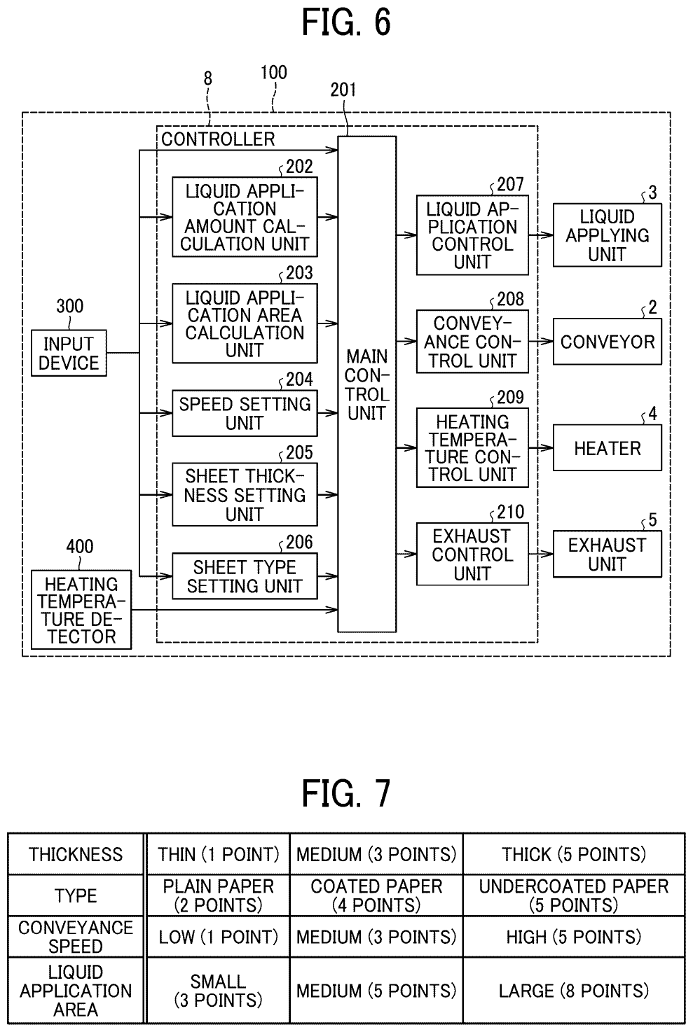

FIG. 6 is a block diagram illustrating an overall configuration of the controller 8 according to the first embodiment.

As illustrated in FIG. 6, the controller 8 includes a main control unit 201, a liquid application amount calculation unit 202, a liquid application area calculation unit 203, a speed setting unit 204, a sheet thickness setting unit 205, a sheet type setting unit 206, a liquid application control unit 207, a conveyance control unit 208, a heating temperature control unit 209, and an exhaust control unit 210.

The liquid application amount calculation unit 202 calculates the amount of liquid applied to the sheet based on the image information input by the input device 300. The input device 300 is, for example, an external device, such as a personal computer (PC) or a touch panel input device, external to the image forming system 100. The liquid application amount is calculated as the amount of liquid applied per unit area or unit time. The liquid application amount calculation unit 202 transmits the information on the calculated liquid application amount to the main control unit 201.

The liquid application area calculation unit 203 calculates the area where the liquid is applied onto the sheet (liquid application area) based on the image information input by the input device 300. The liquid application area is calculated as the area (area ratio) of application of liquid per unit area or unit time. The liquid application area calculation unit 203 transmits the information on the calculated liquid application area to the main control unit 201.

The speed setting unit 204 sets the conveyance speed of the sheet based on the speed information input by the input device 300. The speed setting unit 204 transmits the information on the set conveyance speed to the main control unit 201.

The sheet thickness setting unit 205 sets the thickness of the sheet based on the thickness information input by the input device 300. The thickness information thus input may be the thickness set in advance for each sheet type. Instead of the thickness, the basis weight (weight in grams per square meter) correlated with the sheet thickness may be used. The basis weight is a value representing the mass per unit area of the sheet. Typically, as the basis weight increases, the thickness of the sheet also increases. The sheet thickness setting unit 205 transmits the information on the set sheet thickness to the main control unit 201.

The sheet type setting unit 206 sets the type of sheet based on type information input by the input device 300. Examples of sheet type include plain paper, coated paper having a coating layer, and undercoated paper having an undercoat layer formed on the coating layer. The sheet type setting unit 206 transmits the information on the set sheet type to the main control unit 201.

The main control unit 201 controls the entire operation of the image forming system 100. Specifically, the main control unit 201 is implemented by the CPU 501, the ROM 502, the RAM 503, and the NVRAM 504 illustrated in FIG. 2, and related elements.

The main control unit 201 generates an image formation control signal based on image information input by the input device 300. When an image formation control signal is transmitted from the main control unit 201 to the liquid application control unit 207, the liquid application control unit 207 controls the liquid application operation of the liquid applying unit 3 according to the received control signal. As a result, an image corresponding to the image information is formed on the sheet. The liquid application control unit 207 includes the main scanning driver 508 and the liquid discharge driver 509 illustrated in FIG. 2.

The main control unit 201 generates a conveyance speed control signal based on the information on the conveyance speed set by the speed setting unit 204. When the conveyance speed control signal is transmitted from the main control unit 201 to the conveyance control unit 208, the conveyance control unit 208 controls the conveyance operation of the conveyor 2 according to the received control signal. Thus, a sheet is conveyed at the set speed. The conveyance control unit 208 includes the sub-scanning driver 510 illustrated in FIG. 2.

The main control unit 201 generates a heating temperature control signal based on the information on the temperature detected by the heating temperature detector 400, the information on the liquid application amount calculated by the liquid application amount calculation unit 202, and the thickness information set by the sheet thickness setting unit 205. The heating temperature detector 400 is a contact or noncontact temperature sensor that detects the temperature of the heating roller 21 or the heating drum 22 of the heater 4. When the heating temperature control signal is transmitted from the main control unit 201 to the heating temperature control unit 209, the heating temperature control unit 209 controls the heating temperature of the heater 4 according to the received control signal. Thus, effective heating of the sheet is performed. In other words, since the thermal energy for drying the sheet differs depending on the thickness of the sheet and the temperature of the heating roller 21 or the heating drum 22 in addition to the amount of liquid applied to the sheet, the main control unit 201 controls the temperature of the heating roller 21 or the heating drum 22 based on the information on the liquid application amount, the information on the thickness of the sheet, and the information on the temperature of the heating roller 21 or the heating drum 22. As a result, drying the sheet is effectively promoted.

The main control unit 201 generates an exhaust volume control signal based on at least one of the information on the liquid application area calculated by the liquid application area calculation unit 203, the information on the conveyance speed set by the speed setting unit 204, the information on the sheet thickness set by the sheet thickness setting unit 205, and the information on the sheet type set by the sheet type setting unit 206. When the exhaust volume control signal is transmitted from the main control unit 201 to the exhaust control unit 210, the exhaust control unit 210 controls the exhaust volume by the exhaust unit 5 according to the received control signal.

### Exhaust Volume Control Method

The exhaust volume control method according to the first embodiment will be described below.

FIG. 7 is a diagram illustrating an exhaust volume setting table used for setting the exhaust volume.

For setting the exhaust volume, four exhaust-volume setting items: “thickness” of the sheet, “type” of the sheet, “conveyance speed,” and “liquid application area” are exemplified. The “thickness,” the “type,” the “conveyance speed,” and the “liquid application area” are items related to the amount of vapor arising from the sheet. For example, as the “thickness” of the sheet increases, the amount of moisture contained in the sheet increases, and the amount of vapor released from the sheet also increases. As indicated in the parentheses in FIG. 7, a score is set in advance for each level of these items. The score is a value set based on the amount of vapor arising from the sheet. The larger the score, the higher the level of the vapor amount. In this case, as the “thickness” of the sheet increases, the amount of moisture contained in the sheet increases, and accordingly, the score is set to be higher such that 1 point for a thin sheet, 3 points for a medium sheet, and 5 points for a thick sheet.

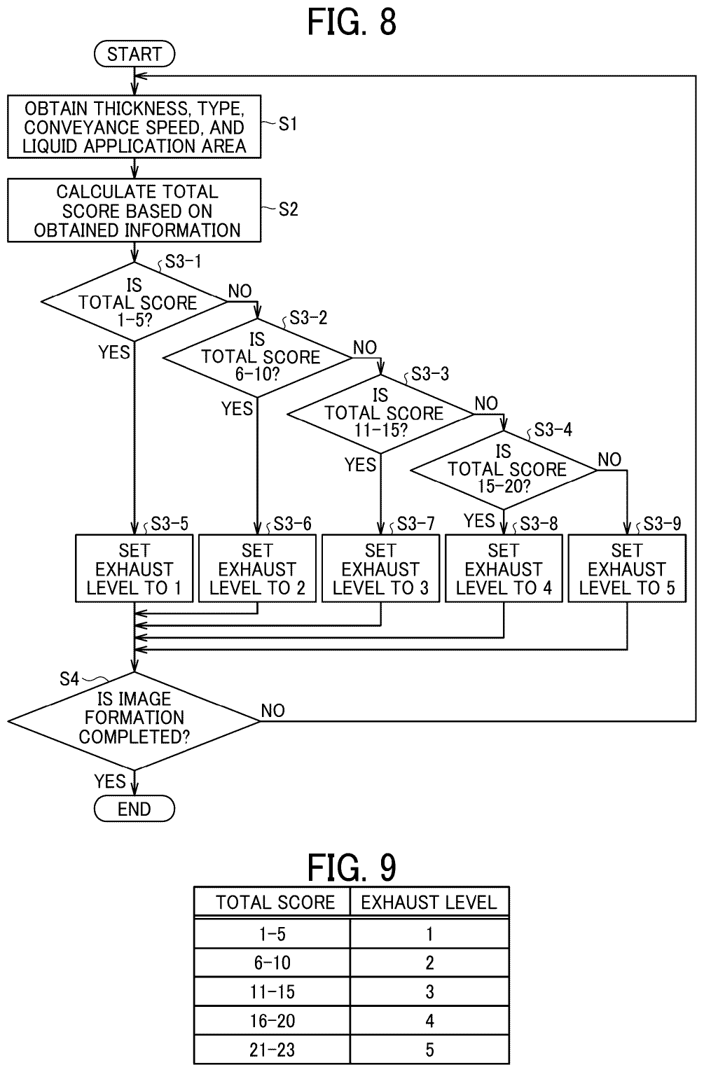

FIG. 8 is a flowchart of a process for controlling the exhaust volume using the exhaust volume setting table.

When the control of the exhaust unit 5 is started in accordance with the start of image formation, in S1, the controller 8 obtains various information. Specifically, the main control unit 201 in FIG. 6 obtains the information on the “thickness” of the sheet set by the sheet thickness setting unit 205, the “type” of the sheet set by the sheet type setting unit 206, the “conveyance speed” set by the speed setting unit 204, and the “liquid application area” calculated by the liquid application area calculation unit 203.

In S2, the controller 8 extracts the score set for the level of each item using the exhaust volume setting table of FIG. 7 and calculating the total score. Assume the case where the sheet is a thin coated paper, the conveyance speed is high, and the liquid application area is large. In this case, the scores corresponding to the levels of the items are: 1 point for the thickness “thin,” 4 points for the sheet type “coated paper,” 5 points for the conveyance speed “high,” and 8 points for the liquid application area “large.” When these scores are added, the total score is 18 points.

When the controller 8 calculates the total score, in S3-1 to S3-4, the controller 8 sets an exhaust volume level based on the calculated total score. As illustrated in FIG. 9, five levels of the exhaust volume are set according to the total score. The numeral of the exhaust volume level indicates the magnitude of the exhaust volume, and the exhaust volume level is set to be higher as the total score increases. When the total score is determined to be 1 to 5 in S3-1, the exhaust volume level is set to “1” in S3-5. Otherwise, the process is advanced to S3-2. When the total score is determined to be 6 to 10 in S3-2, the exhaust volume level is set to “2” in S3-6. Otherwise, the process is advanced to S3-3. When the total score is determined to be 11 to 15 in S3-3, the exhaust volume level is set to “3” in S3-7. Otherwise, the process is advanced to S3-4. For example, when the total score is 18, the exhaust volume level is set to “4” in S3-8. Otherwise, the exhaust volume level is set to “5” in S3-9. The number of exhaust volume levels is not limited to five but is at least two.

The same control process is repeated until the image formation ends in S4. When the image formation ends, the control of the exhaust volume also ends.

As described above, according to the first embodiment of the present disclosure, the total score is calculated according to the amount of vapor arising from the sheet, and the exhaust volume is set based on the calculated total score. Thus, the exhaust volume is set according to the amount of vapor. This control can reduce energy loss relating to exhaust as compared with the case where the exhaust volume is set according to the condition under which the amount of arising vapor is the largest. Reducing energy loss relating to exhaust can achieve energy saving.

The exhaust volume can be controlled by controlling the air volume of the exhaust fan 31 by, for example, pulse-width modulation (PWM). The air volume (Q [m³/h]) represents the amount of air moved per unit time by the exhaust fan 31 and is expressed by a multiplier of the passing air velocity V [m/s] and the passing area A [m²]. The air volume is measured using, for example, a hot-wire anemometer or a vane anemometer.

Instead of or in addition to adjusting the air volume of the exhaust fan 31, the aperture of the exhaust duct 32 may be changed by, for example, a damper, to control the exhaust volume.

The amount of vapor arising from the sheet can be measured by a general humidity sensor when the vapor contains only moisture. The term “amount of vapor” represents the amount (e.g., mass, weight, or amount of substance) of vapor in a unit volume. When the relative humidity and temperature of the vapor are known, the absolute humidity can be calculated, and the amount of vapor can be determined. When the vapor contains moisture and a solvent, the amount of vapor can be determined by estimating the amount of the solvent from the measurement result of the humidity sensor.

The amount of vapor arising from the sheet differs depending on the size of the pattern (image pattern) in which liquid is applied to the sheet. Accordingly, the exhaust volume may be controlled according to the liquid application pattern that changes in one image forming job. This enables the control in real-time of the exhaust volume according to the change in the liquid application pattern, and the exhaust volume can be set more accurately corresponding to changes in the amount of vapor.

In the description above, the exhaust volume may be controlled based on the information on each of the “thickness” of the sheet, the “type” of the sheet, the “conveyance speed,” and the “liquid application area.” Alternatively, the exhaust volume may be controlled based on the information on at least one of these items. Further, the exhaust volume may be controlled using the “liquid application amount” calculated by the liquid application amount calculation unit 202 of FIG. 6 instead of the “liquid application area.”

In the case where the exhaust volume is controlled based on the “liquid application area,” if the exhaust volume frequently fluctuates with changes in the liquid application area, the rotation speed of the exhaust fan 31 increases or decreases. Then, the driving noise of the exhaust fan 31 may be unpleasant. Further, if the rotation speed of the exhaust fan 31 frequently fluctuates, the exhaust fan 31 may deteriorate.

In view of this, the liquid application area calculation unit 203 may calculate the “cumulative average value” of the liquid application area for every predetermined time of liquid application, for every predetermined conveyance distance of the sheet, or for every predetermined number of pages of the image so that the exhaust volume is controlled based on the calculated “cumulative average value” of the liquid application area. The predetermined time, conveyance distance, or number of pages can be stored in a memory, for example, by a manufacturer based on empirical data. Specifically, the liquid application area calculation unit 203 calculates the “cumulative average value” of the liquid application area for every 10 pages of the image forming job. Then, the main control unit 201 corrects the score of the liquid application area in FIG. 7 based on the calculated “cumulative average value” and sets the exhaust volume level based on the total score calculated using the corrected score.

Controlling the exhaust volume based on the “cumulative average value” of the liquid application area calculated for every predetermined number of pages, every predetermined time, or every predetermined conveyance distance can alleviate the driving noise and the deterioration of the exhaust fan 31 due to frequent fluctuations of the exhaust volume.

Other embodiments of the present disclosure are described below. In the following description, differences from the above-described first embodiment are focused, and redundant descriptions are simplified or omitted.

### Second Embodiment

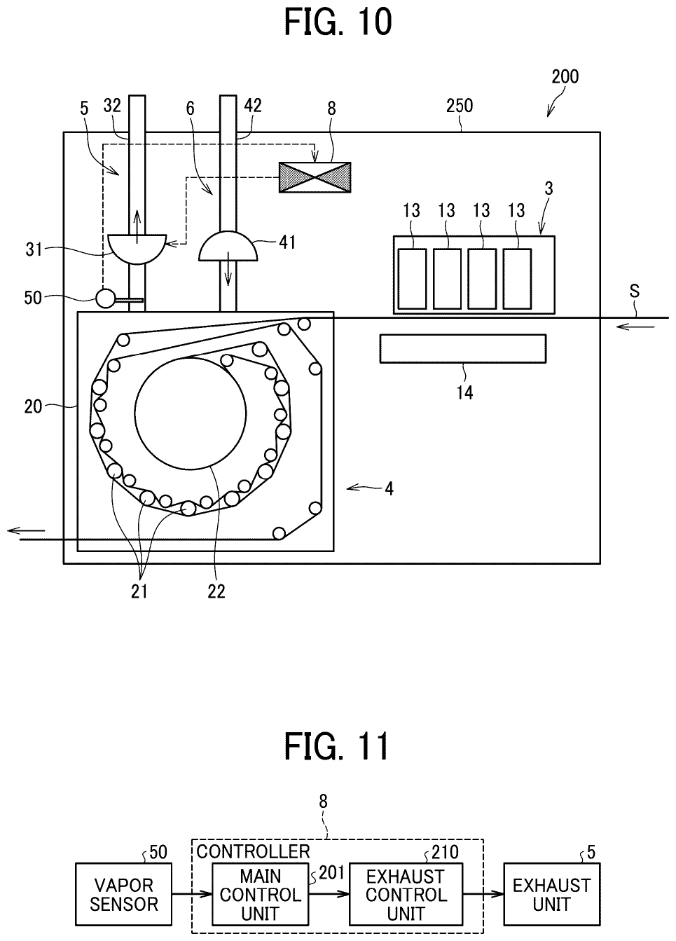

FIG. 10 is a schematic diagram illustrating a configuration of an image forming apparatus 200 according to a second embodiment.

As illustrated in FIG. 10, in the second embodiment, the image forming apparatus 200 includes a vapor sensor 50 to detect the amount of vapor. The vapor sensor 50 is provided for the exhaust duct 32. When the sheet S is heated in the heater 4, the vapor arising from the sheet S is exhausted through the exhaust duct 32. Accordingly, detecting the amount of vapor in the exhaust duct 32 with the vapor sensor 50 enables determining the amount of vapor arising from the sheet S. The vapor sensor 50 may be a humidity sensor that detects the amount of water vapor, a solvent sensor that detects the amount of vaporized solvent, a sensor including functions of both the humidity sensor and the solvent sensor.

In the second embodiment, the controller 8 controls the exhaust volume by the exhaust unit 5 based on the “vapor amount” detected by the vapor sensor 50.

FIG. 11 is a block diagram illustrating a configuration of a part of the controller 8 according to the second embodiment.

As illustrated in FIG. 11, the main control unit 201 of the controller 8 obtains information on the amount of vapor detected by the vapor sensor 50 from the vapor sensor 50. The main control unit 201 generates an exhaust volume control signal based on the obtained vapor amount. When the exhaust volume control signal is transmitted from the main control unit 201 to the exhaust control unit 210, the exhaust control unit 210 controls the exhaust volume by the exhaust unit 5 according to the received control signal. Thus, the exhaust volume is set in accordance with the amount of vapor arising from the sheet.

In this way, the exhaust volume may be controlled based on the “vapor amount” detected by the vapor sensor 50. Also in this case, the exhaust volume can be set according to the amount of vapor arising from the sheet, and energy loss relating to exhaust can be reduced. As a result, energy saving is achieved.

### Third Embodiment

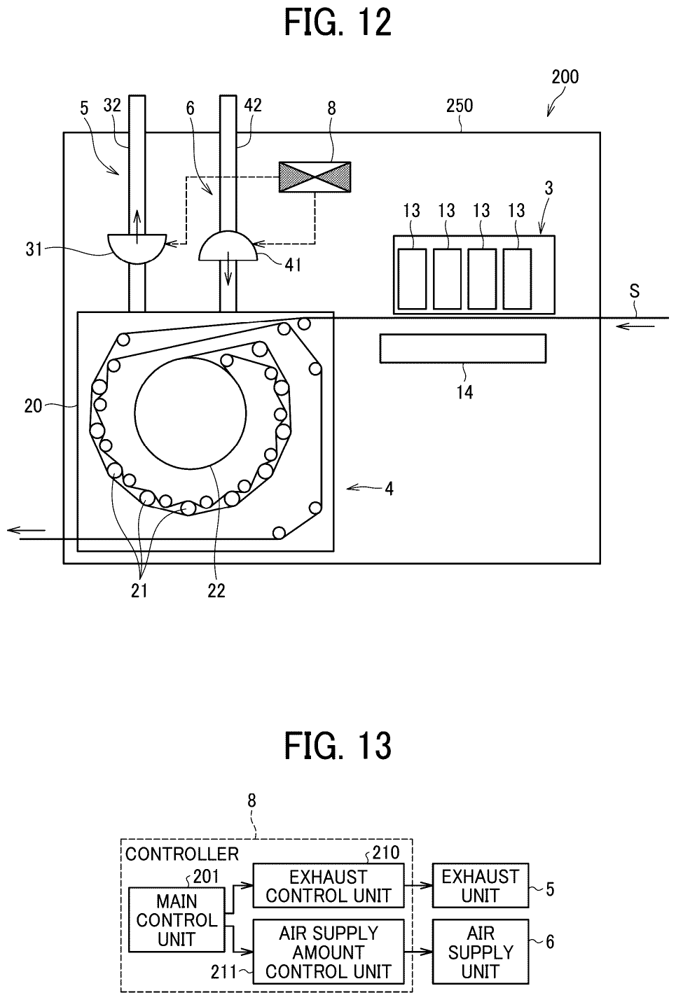

FIG. 12 is a schematic diagram illustrating a configuration of the image forming apparatus 200 according to a third embodiment.

As illustrated in FIG. 12, the controller 8 according to the third embodiment controls the air supply unit 6 in addition to the exhaust unit 5.

FIG. 13 is a block diagram illustrating a configuration of a part of the controller 8 according to the third embodiment.

As illustrated in FIG. 13, the controller 8 according to the third embodiment includes, in addition to the exhaust control unit 210, an air supply amount control unit 211 that controls the air supply amount of the air supply unit 6. When generating the exhaust volume control signal, the main control unit 201 generates an air supply amount control signal based on the exhaust volume at that time. When the air supply amount control signal is transmitted from the main control unit 201 to the air supply amount control unit 211, the air supply amount control unit 211 controls the amount of air supplied by the air supply unit 6 according to the received control signal. The amount of air supplied may be controlled by, for example, controlling the airflow rate of the air supply fan 41 of the air supply unit 6 or changing the aperture of the air supply duct 42. In FIG. 13, the main control unit 201 may control the exhaust volume based on at least one of the “thickness” of the sheet, the “type” of the sheet, the “conveyance speed,” and the “liquid application area” or based on the “vapor amount” detected by the vapor sensor 50.

In this way, the air pressure in the heater 4 can be kept at a predetermined pressure by controlling the amount of air supplied based on the exhaust volume. That is, the main control unit 201 performs control operation such that, when the exhaust volume is increased, the air supply amount is increased in accordance with the increase of the exhaust volume. As a result, fluctuations of the air pressure in the heater 4 can be reduced. Under normal operating conditions, the air pressure in the heater 4 is preferably set to a negative pressure to prevent leakage of vapor to the outside of the heater 4. Controlling the amount of supplied air according to the exhaust volume as in the third embodiment can maintain a negative pressure inside the heater 4, and the vapor inside the heater 4 can be effectively prevented from leaking.

### Fourth Embodiment

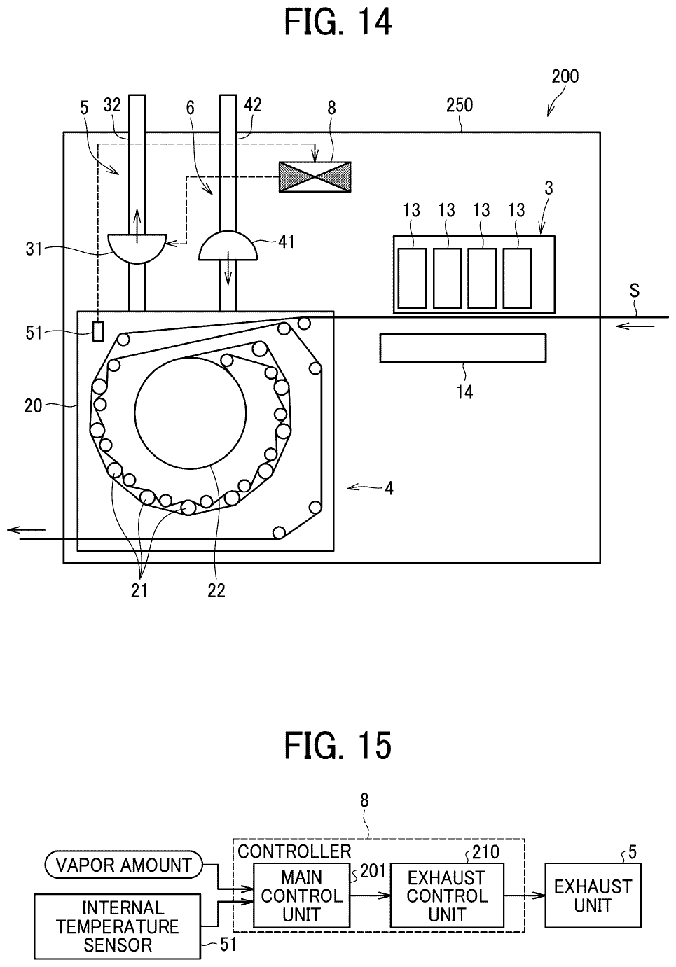

FIG. 14 is a schematic diagram illustrating a configuration of the image forming apparatus 200 according to a fourth embodiment of the present disclosure.

As illustrated in FIG. 14, the heater 4 according to the fourth embodiment includes an internal temperature sensor 51 therein to detect the temperature inside the heater 4.

FIG. 15 is a block diagram illustrating a configuration of a part of the controller 8 according to the fourth embodiment.

As illustrated in FIG. 15, the controller 8 according to the fourth embodiment controls the exhaust volume by the exhaust unit 5 based on both the “amount of vapor” from the sheet and the “temperature” detected by the internal temperature sensor 51. The “amount of vapor” from the sheet may be calculated based on at least one of the “thickness” of the sheet, the “type” of the sheet, the “conveyance speed,” and the “liquid application area” or may be the “amount of vapor” detected by the vapor sensor 50.

Exhausting the vapor from the heater 4 to the outside of the apparatus can reduce dew condensation in the heater 4. However, the vapor in the heater 4 is likely to condense immediately after the start of image formation or when the room temperature is low because the temperature inside the heater 4 is low. In view of this, when the temperature in the heater 4 is low, the exhaust volume is preferably increased to reduce dew condensation.

Accordingly, the exhaust volume is controlled based on the temperature inside the heater 4 in addition to the amount of vapor arising from the sheet. Thus, the exhaust volume is controlled according to the temperature inside the heater 4. For example, when the temperature inside the heater 4 is low because image formation has just started, the exhaust volume level is increased by one compared with the case where the temperature is high. This control can effectively reduce dew condensation when the temperature is low. Further, when the temperature inside the heater 4 is increased by the image formation, the exhaust volume level is lowered by one to the original level, thereby reducing the energy loss relating to the exhaust.

In the description about the fourth embodiment, the controller 8 does not control the air supply unit 6 based on the exhaust volume, but the controller 8 may control the air supply unit 6 based on the exhaust volume.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention. Any one of the above-described operations may be performed in various other ways, for example, in an order different from the one described above.

The present disclosure is applicable to not limited to the image forming system to form an image on a sheet but also other liquid application systems. For example, the present disclosure may be applied to a liquid application system that applies to the sheet, for example, a treatment liquid for modifying the surface property thereof before image formation. The present disclosure is also applicable to a liquid application system that applies liquid to a sheet by a method other than discharge, such as applying liquid to a sheet using a roller. The heater included in the liquid application system may be a device that heats a sheet for a purpose other than drying, such as fixing an image on the sheet.

The sheet used may be any sheet to which liquid at least temporarily adheres, such as a sheet onto which liquid adheres and solidifies or a sheet into which liquid adheres to permeate. Specifically, examples of the sheet include resin film, wall paper, and an electronic substrate in addition to paper sheets.

Examples of the material of the sheet include paper, leather, metal, plastic, glass, wood, and ceramics. Further, the sheet is not limited to a long sheet continuously conveyed from the sheet feeder to the sheet collecting unit without interruption but may be short sheets individually conveyed one by one from the sheet feeder to the sheet collecting unit.

The liquid applied to the sheet is not limited. Examples of the liquid include water, a solvent such as an organic solvent, a solution, a suspension, and an emulsion. For example, the solution, the suspension, and the emulsion contain a colorant such as a dye or a pigment; a polymerizable compound; resin; a functionalization material such as a surfactant; a biocompatible material such as a deoxyribonucleic acid (DNA), an amino acid, a protein, or calcium; or an edible material such as a natural colorant. Such a solution, a suspension, or an emulsion can be used for, e.g., inkjet ink, surface treatment liquid, a liquid for forming components of electronic element or light-emitting element, a resist pattern of electronic circuit, or a three-dimensional fabrication material solution.

The above-described embodiments of the present disclosure have at least the following aspects.

A liquid application system according to a first aspect of disclosure includes a liquid applying unit that applies a liquid to a sheet, a heater that heats the sheet to which the liquid is applied, an exhaust unit that exhausts air from the heater, and a controller that controls the exhaust unit. The controller controls the volume of exhaust by the exhaust unit based on the amount of vapor arising from the sheet in the heater.

The heater may have the dedicated housing 20 as illustrated in FIG. 1. Alternatively, the heater may be accommodated in not the dedicated housing but the housing 250 of the image forming apparatus 200 together with, for example, the liquid applying unit 3. Accordingly, the exhaust unit that exhausts air from the heater may be any means for exhausting the air from the housing containing at least a heating means such as the heating roller 21 or the heating drum 22 in FIG. 1 to the outside of the housing. For example, in a case where the heater 4 is accommodated in not the dedicated housing 20 illustrated in FIG. 1 but the housing 250 of the image forming apparatus 200 together with, for example, the liquid applying unit 3, the exhausting means may be any means for exhausting air from the housing 250 of the image forming apparatus 200 to the outside. The amount of vapor may be the amount of water vapor arising from the sheet and the liquid on the sheet, or the amount of vaporized solvent from the liquid on the sheet. The amount of vapor may contain both water vapor and vaporized.

In a second aspect, in the liquid application system according to the first aspect, the controller controls the exhaust volume by the exhaust unit based on at least one of a thickness of the sheet, a type of the sheet, a conveyance speed of the sheet, and a liquid application area on the sheet.

In a third aspect, in the liquid application system according to the first or second aspect, the controller controls the exhaust volume by the exhaust unit in accordance with a change in a pattern of the liquid applied to the sheet.

In a fourth aspect, in the liquid application system according to any one of the first to third aspects, the controller controls the exhaust volume by the exhaust unit based on a cumulative average value of the liquid application area calculated for every predetermined number of pages, every predetermined time, or every predetermined conveyance distance of the sheet.

In a fifth aspect, the liquid application system according to the first aspect includes a vapor sensor that detects the amount of vapor arising from the sheet in the heater, and the controller controls the exhaust volume by the exhaust unit based on the amount of vapor detected by the vapor sensor.

In a sixth aspect, the liquid application system according to any one of the first to fifth aspects further includes an air supply unit that supplies air into the heater, and the controller controls the amount of air supplied by the air supply unit based on the exhaust volume by the exhaust unit.

The heater to which air is supplied by the air supply unit may have the dedicated housing 20 as illustrated in FIG. 1. Alternatively, the heater may be accommodated in the housing 250 of the image forming apparatus 200 together with, for example, the liquid applying unit 3. Accordingly, the air supply unit may be any means for supplying air into the housing containing at least the heater therein.

In a seventh aspect, the liquid application system according to any one of the first to sixth aspects further includes an internal temperature sensor disposed inside the heater to detect the temperature inside the heater, and the controller controls the exhaust volume by the exhaust unit based on both the amount of vapor arising from the sheet inside the heater and the temperature detected by the internal temperature sensor.

The heater inside which the internal temperature sensor is disposed may have the dedicated housing 20 as illustrated in FIG. 1. Alternatively, the heater may be accommodated in the housing 250 of the image forming apparatus 200 together with, for example, the liquid applying unit 3. Accordingly, the internal temperature sensor may be any means that detects the temperature inside the housing containing at least the heater therein.

In an eighth aspect, the liquid application system according to any one of the first to seventh aspects is an image forming system that applies the liquid to the sheet to form an image on the sheet.

An exhaust volume control method according to a ninth aspect includes controlling the exhaust volume from a heater that heats a sheet based on the amount of vapor arising from the sheet in the heater.

The functionality of the elements disclosed herein may be implemented using circuitry or processing circuitry which includes general purpose processors, special purpose processors, integrated circuits, application-specific integrated circuits (ASICs), field- programmable gate arrays (FPGAs), and/or combinations thereof which are configured or programmed, using one or more programs stored in one or more memories, to perform the disclosed functionality. Processors are considered processing circuitry or circuitry as they include transistors and other circuitry therein. In the disclosure, the circuitry, units, or means are hardware that carry out or are programmed to perform the recited functionality. The hardware may be any hardware disclosed herein which is programmed or configured to carry out the recited functionality.

There is a memory that stores a computer program which includes computer instructions. These computer instructions provide the logic and routines that enable the hardware (e.g., processing circuitry or circuitry) to perform the method disclosed herein. This computer program can be implemented in known formats as a computer-readable storage medium, a computer program product, a memory device, a record medium such as a CD- ROM or DVD, and/or the memory of an FPGA or ASIC.

1. A liquid application system comprising:
a liquid discharger to apply a liquid to a sheet;
a heater to heat the sheet to which the liquid is applied;
an exhauster to exhaust air from the heater; and
circuitry configured to control an exhaust volume by the exhauster based on an amount of vapor from the sheet in the heater.

2. The liquid application system according to claim 1, further comprising a conveyor to convey the sheet,
wherein the circuitry is configured to control the exhaust volume by the exhauster based on at least one of a thickness of the sheet, a type of the sheet, a speed of the sheet conveyed by the conveyor, or a liquid application area on the sheet.

3. The liquid application system according to claim 1,
wherein the circuitry is configured to control the exhaust volume by the exhauster in accordance with a change in a pattern of the liquid applied to the sheet.

4. The liquid application system according to claim 1,
wherein the circuitry is configured to control the exhaust volume by the exhauster based on a cumulative average value of a liquid application area on the sheet calculated for every predetermined number of pages, every predetermined time, or every predetermined conveyance distance of the sheet.

5. The liquid application system according to claim 1, further comprising a vapor sensor to detect an amount of vapor from the sheet in the heater,
wherein the circuitry is configured to control the exhaust volume by the exhauster based on the amount of vapor detected by the vapor sensor.

6. The liquid application system according to claim 1, further comprising an air supplier to supply air into the heater,
wherein the circuitry is configured to control an amount of air supplied by the air supplier based on the exhaust volume by the exhauster.

7. The liquid application system according to claim 1, further comprising
a temperature sensor disposed inside the heater to detect temperature inside the heater,
wherein the circuitry is configured to control the exhaust volume by the exhauster based on the amount of vapor from the sheet in the heater and the temperature detected by the temperature sensor.

8. The liquid application system according to claim 1, further comprising:
an image forming device to apply the liquid to the sheet to form an image on the sheet.

9. A method for controlling an exhaust volume from a heater that heats a sheet, the method comprising
controlling the exhaust volume from the heater based on an amount of vapor from the sheet in the heater.
